(19) United States
(12) Patent Application Publication
(10) Pub. No.: US 2019/0095885 A1
(43) Pub. Date: Mar. 28, 2019

(54) PAYMENT PROCESSING SYSTEM AND PAYMENT PROCESSING METHOD

(71) Applicant: HITACHI, LTD., Tokyo (JP)

(72) Inventors: Takashi YAMAGISHI, Tokyo (JP); Norimitsu SHIMIZU, Tokyo (JP)

(21) Appl. No.: 16/083,098

(22) PCT Filed: Mar. 9, 2016
(86) PCT No.: PCT/JP2016/057406

§ 371 Date: Sep. 7, 2018

(51) Int. Cl. G06Q 20/10; G06Q 20/40

(52) U.S. Cl. CPC G06Q 20/102; G06Q 20/40

(57) ABSTRACT

A settlement processing system includes an operation device which, when current position information obtained from a store terminal shows the inside of a predetermined area shown by registration position information of the store, obtains a predetermined code and settlement information corresponding to a settlement opportunity generated for a user of the store and stores a predetermined code and the settlement information in a storage device, according to the settlement opportunity, specifies a store located at a current position of the user terminal, on the basis of current position information of the user terminal and the registration position information, and when a predetermined code held for the store and the predetermined code included in the payment request are matched with each other, requests an accounting system to execute remittance processing between settlement accounts of the user and the store, on the basis of settlement information associated with the predetermined code.

### TECHNICAL FIELD

The present invention relates to a settlement processing system and a settlement processing method.

### BACKGROUND ART

Presently, various settlement mechanisms are provided from financial institutions, settlement agents, and the like. For example, in addition to existing cash, credit cards, debit cards, and prepaid cards correspond to them. With diversification of the settlement mechanisms, advancement of settlement to realize a cashless society is promoted.

As conventional technologies associated with the settlement, the following technologies are suggested. That is, a method (refer to PTL 1) for receiving content of products and services ordered from a terminal device coupled to a management device processing orders of products to be purchased at facilities and services to be provided at the facilities via a communication line by the management device, the method including a step of receiving position information showing a position of the terminal device transmitted from the terminal device by the management device, a step of transmitting names of the facilities located in a predetermined range from the position of the terminal device to the terminal device by the management device to display the names on the terminal device, on the basis of the position information, a step of receiving a name of a designated facility in the names of the facilities from the terminal device, a step of transmitting a list of products to be sold at the designated facility and services to be provided at the designated facility to the terminal device by the management device to display the list on the terminal device, and a step of receiving the names of the products and the services selected from the list from the terminal device and storing the names in a predetermined memory of the management device, is suggested.

As a system for enabling product purchase by card settlement without requiring presentation of a credit card, a settlement system for a mobile terminal (refer to PTL 2) in which software obtained from a server by a smartphone of a user is used to transmit customer information and card information such as a card number to the server, the server transmits the customer information and the card information to a PC of a credit card company, requests the PC to authenticate whether or not a registration is acceptable as a customer; deletes the card information when the authentication is obtained, stores the customer information in a DB, and determines the user as a registered customer, the customer information is transmitted to a store PC from a smartphone of the registered customer, the PC requests the server to confirm the customer information, the server requests the PC to approve card settlement, and when the card settlement is approved by the PC, the server requests the registered customer to agree to the card settlement, and transmits a message of settlement completion to each PC on receiving a reply of the card settlement agreement is suggested.

### CITATION LIST

### Patent Literature

PTL 1: JP 2014-56558 A

PTL 2: JP 2015-122045 A

### SUMMARY OF INVENTION

### Technical Problem

Credit card settlement is useful in that cashless and quick settlement is enabled. However, to execute the credit card settlement, a considerable settlement fee is required.

Meanwhile, in small capital stores, there are situations in which it is difficult to add the settlement fee to an amount charged to a customer, because of concerns about sales opportunities and loss of customers. On the other hand, if the settlement fee is not added to the amount charged to the customer, store profits should be applied as a source of the settlement fee.

For this reason, in the small capital stores, it is not easy to introduce cashless settlement represented by the credit card settlement and it is difficult to achieve quick and diversify settlement.

Accordingly, an object of the present invention is to provide technology for enabling quick and low-cost cashless settlement.

### Solution to Problem

A settlement processing system according to the present invention for solving the above problems includes: a storage device which stores registration position information showing a location of each store, settlement account information of the store, and settlement account information of a user of each store; and an operation device which executes processing for, when current position information obtained from a store terminal of the store shows the inside of a predetermined area shown by the registration position information of the store, obtaining a predetermined code and settlement information corresponding to a settlement opportunity generated for the user of the store, from the store terminal and storing the predetermined code and the settlement information in the storage device, according to the settlement opportunity, and processing for, when a payment request including the predetermined code is obtained from a predetermined user terminal, specifying a store located at a current position of the user terminal, on the basis of current position information obtained from the user terminal and the registration position information, and when a predetermined code held for the store and the predetermined code included in the payment request are matched with each other, requesting an accounting system to execute remittance processing between settlement accounts of the user and the store, on the basis of settlement information associated with the predetermined code and the settlement account information of the store and the user.

Further, in a settlement processing method according to the present invention, an information processing system, which includes a storage device storing registration position information showing a location of each store, settlement account information of the store, and settlement account information of a user of each store, executes processing for, when current position information obtained from a store terminal of the store shows the inside of a predetermined area shown by the registration position information of the store, obtaining a predetermined code and settlement information corresponding to a settlement opportunity generated for the user of the store, from the store terminal and storing the predetermined code and the settlement information in the storage device, according to the settlement opportunity, and processing for, when a payment request including the predetermined code is obtained from a predetermined user terminal, specifying a store located at a current position of the user terminal, on the basis of current position information obtained from the user terminal and the registration position information, and when a predetermined code held for the store and the predetermined code included in the payment request are matched with each other, requesting an accounting system to execute remittance processing between settlement accounts of the user and the store, on the basis of settlement information associated with the predetermined code and the settlement account information of the store and the user.

### Advantageous Effects of Invention

According to the present invention, quick and low-cost cashless settlement is enabled.

### BRIEF DESCRIPTION OF DRAWINGS

FIG. 1 is a network configuration diagram including a settlement processing system according to this embodiment.

FIG. 2 is a diagram showing a hardware configuration example of the settlement processing system according to this embodiment.

FIG. 3 is a diagram showing a hardware configuration example of a store terminal according to this embodiment.

FIG. 4 is a diagram showing a hardware configuration example of a user terminal according to this embodiment.

FIG. 5 is a diagram showing a configuration example of a corporation management table according to this embodiment.

FIG. 6 is a diagram showing a configuration example of a settlement deadline table according to this embodiment.

FIG. 7 is a diagram showing a configuration example of a user management table according to this embodiment.

FIG. 8 is a diagram showing a configuration example of a settlement information table according to this embodiment.

FIG. 9 is a diagram showing a configuration example of a divided settlement information table according to this embodiment.

FIG. 10 is a diagram showing a first flow example of a settlement processing method according to this embodiment.

FIG. 11 is a diagram showing a first screen example according to this embodiment.

FIG. 12 is a diagram showing a second screen example according to this embodiment.

FIG. 13 is a diagram showing a second flow example of the settlement processing method according to this embodiment.

FIG. 14 is a diagram showing a third screen example according to this embodiment.

FIG. 15 is a diagram showing a third flow example of the settlement processing method according to this embodiment.

FIG. 16 is a diagram showing a fourth screen example according to this embodiment.

### DESCRIPTION OF EMBODIMENTS

### ———Network Configuration———

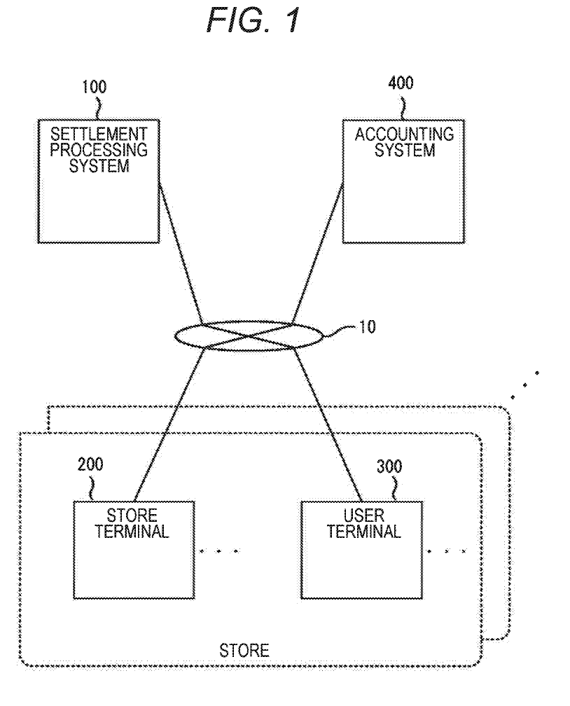

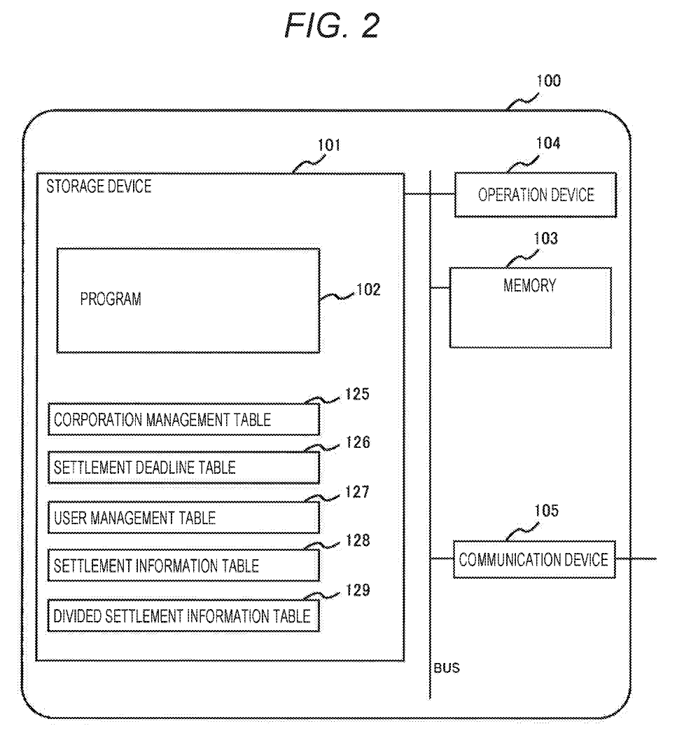

Hereinafter, an embodiment of the present invention will be described in detail using the drawings. FIG. 1 is a diagram showing a network configuration example including a settlement processing system 100 according to this embodiment. The settlement processing system 100 shown in FIG. 1 is a computer system for enabling quick and low-cost cashless settlement.

The settlement processing system 100 is connected to a network 10 and can perform data communication with a store terminal 200, a user terminal 300, and an accounting system 400.

Among them, the store terminal 200 is a terminal used in a store where some settlement is generated. In addition, the user terminal 300 is a terminal of each user who visits the store and purchases products or services. In addition, the accounting system 400 is a system for executing various processing associated with accounting operations in financial institutions.

### ———Hardware Configuration Example———

In addition, a hardware configuration of the settlement processing system 100 is as follows. The settlement processing system 100 includes a storage device 101 that is composed of a suitable non-volatile storage element such as a hard disk drive, a memory 103 that is composed of a volatile storage element such as a RAM, an operation device 104 such as a CPU that reads a program 102 held in the storage device 101 onto the memory 103, executes the program, and performs integrated control of the system and performs various determinations, operations, and control processing, and a communication device 105 that is connected to the network 10 and executes communication processing with other devices.

In addition to the program 102, the storage device 101 holds a corporation management table 125, a settlement deadline table 126, a user management table 127, a settlement information table 128, and a divided settlement information table 129. Data configurations of these tables will be described later.

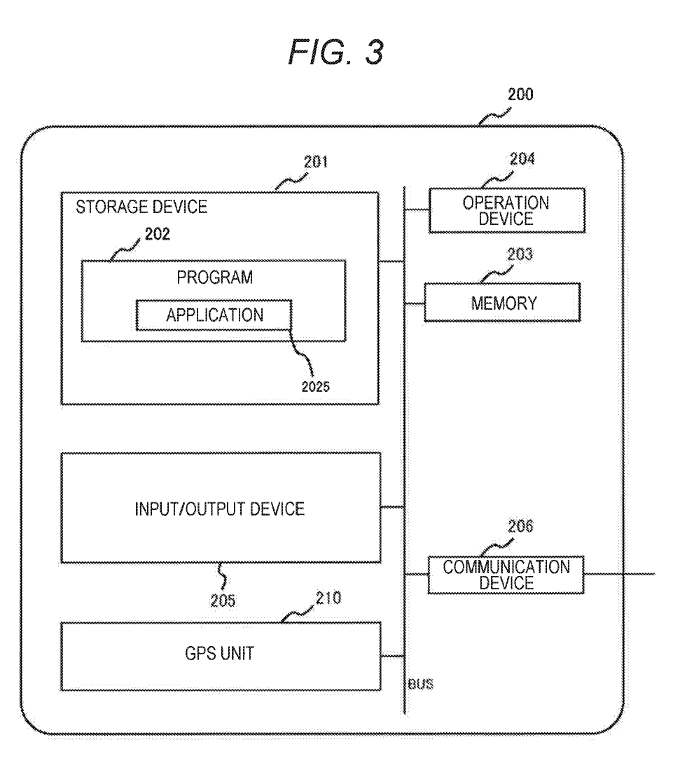

FIG. 3 is a diagram showing a hardware configuration example of the store terminal 200 according to this embodiment. As the store terminal 200 according to this embodiment, for example, a tablet terminal or a notebook PC used by a store staff at the time of settlement operations can be assumed.

Specifically, the store terminal 200 includes a storage device 201 that is composed of a suitable non-volatile storage element such as a hard disk drive, a memory 203 that is composed of a volatile storage element such as a RAM, an operation device 204 such as a CPU that reads a program 202 held in the storage device 201 onto the memory 203, executes the program, and performs integrated control of the system and performs various determinations, operations, and control processing, an input/output device 205 such as a touch panel, a communication device 206 that is connected to the network 10 and executes communication processing with other devices, and a GPS unit 210.

Among them, the GPS unit 210 is a unit that can obtain a signal from a GPS satellite and can measure a current position of the self device. Although positioning accuracy thereof is not particularly limited, an operation for increasing the positioning accuracy in the GPS unit 210 by using various interpolation technologies such as an indoor messaging system (IMES), a mobile phone base station, and a wireless LAN access point is preferably performed.

The program 202 in the storage device 201 includes at least an application 2025 to use functions provided from the settlement processing system 100 according to this embodiment to the store terminal 200.

As main functions, the application 2025 has a function of transmitting current position information obtained by the GPS unit 210 to the settlement processing system 100 together with a store ID of a corresponding store at the time of a settlement opportunity in the store and confirming that the store terminal 200 is located in a settlement enabled area for the store and a function of, in the settlement processing system 100, registering an access code input from a staff of the store (or automatically generated by the application 2025) in association with settlement information regarding the settlement opportunity, through the successful confirmation.

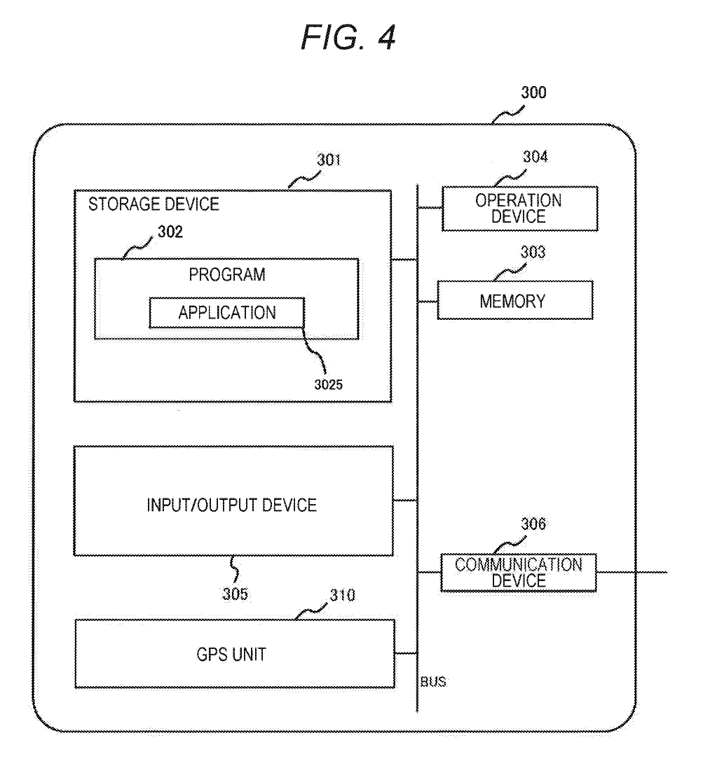

FIG. 4 shows a hardware configuration example of the user terminal 300 according to this embodiment. In this embodiment, the user terminal 300 includes a storage device 301 that is composed of a suitable non-volatile storage element such as a hard disk drive, a memory 303 that is composed of a volatile storage element such as a RAM, an operation device 304 such as a CPU that reads a program 302 held in the storage device 301 onto the memory 303, executes the program, and performs integrated control of the system and performs various determinations, operations, and control processing, an input/output device 305 such as a touch panel, a communication device 306 that is connected to the network 10 and executes communication processing with other devices, and a GPS unit 310.

Among them, a configuration of the GPS unit 310 is the same as the configuration of the GPS unit 210 in the store terminal 200.

The program 302 in the storage device 301 includes at least an application 3025 to use functions provided from the settlement processing system 100 according to this embodiment to the user terminal 300.

As main functions, the application 3025 has a function of transmitting current position information obtained by the GPS unit 310 to the settlement processing system 100 at the time of a settlement opportunity in a corresponding store and confirming a registration store located at a current position of the user terminal 300 and a function of transmitting an access code input by a user using the input/output device 305 to the settlement processing system 100 and requesting for collation with an access code registered for the store, after the confirmation.

### ———Data Configuration Example———

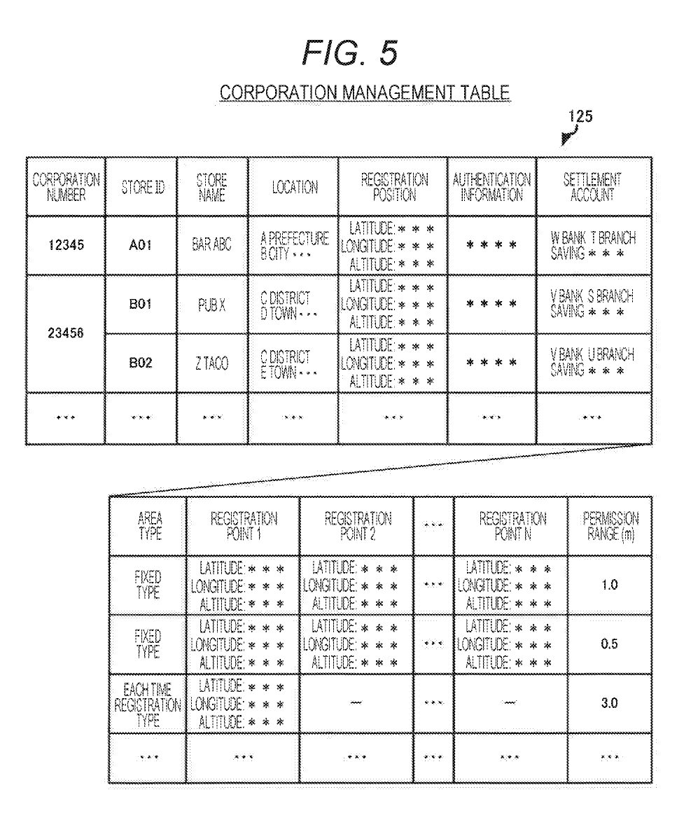

Next, tables to be used by the settlement processing system 100 according to this embodiment will be described. FIG. 5 shows an example of the corporation management table 125 according to this embodiment. The corporation management table 125 is a table that accumulates information regarding each store using the settlement processing system 100. A data structure thereof is an aggregation of records including data such as a store name, a location, a registration position, authentication information, a settlement account, an area type, a registration point, and a permission range of a store, with a corporation number to uniquely specify an operation corporation of the store and a store ID to uniquely specify each store of the operation corporation as a key.

Among them, the location is information corresponding to an address expression in an administrative section and is an address of the store. In addition, the registration position is a GPS coordinate value (that is, current position information) obtained from the GPS unit 210 of the store terminal 200 that has been registered, when information regarding the store is registered in the corporation management table 125. In this embodiment, the location and the registration position are values indicating the same point. In other words, when the GPS coordinate value obtained from the GPS unit 210 is not matched with a position of the location declared from the store side, store registration in the corporation management table 125 is not performed.

In addition, the authentication information is a password required at the time of using the application 2025 used by the store terminal 200 of the store. The authentication information may not be stored in the corporation management table 125 but may be held by the application 2025 and subjected to authentication processing.

In addition, the settlement account is a bank account to be a remittance destination in remittance processing from a user who is a customer of a store to the store, at the time of a settlement opportunity in the store.

In addition, the area type is a type of settlement enabled area determined according to whether the store is a fixed type of store located in a building or the store is a mobile store moved by a vehicle. For example, in the case where the store is “fixed type”, a section including the location or the registration position of the store partially or overall becomes the settlement enabled area. On the other hand, in the case where the store is “each time registration type”, a circular section (of course, a section shape is an example) of a constant range based on the location or the registration position of the store becomes the settlement enabled area.

Information for specifying the settlement enabled area becomes the “registration point”. In the case of the area type “fixed type”, the “registration point” becomes a GPS coordinate value of each vertex in the shape of the settlement enabled area. On the other hand, in the case of the area type “each time registration type”, the “registration point” becomes a GPS coordinate value of a center point of the circular settlement enabled area.

In addition, the “permission range” is a value that defines a permission range in which it can be determined that a current position of the user terminal 300 is included in a range of the registration position or the settlement enabled area of the store. For example, in the case of the area type “fixed type”, the permission range becomes a distance from a boundary line defining the settlement enabled area (a registration point 1, a registration point 2, . . . ) of the store. Therefore, when the current position of the user terminal 300 is outside the settlement enabled area, but the user terminal 300 is located between the boundary line of the area and the distance of the permission range, it is determined that the user terminal 300 is located in the settlement enabled area of the store. On the other hand, in the case of the area type “each time registration type”, the permission range becomes a distance from the registration position or the settlement enabled area (registration point 1) of the store.

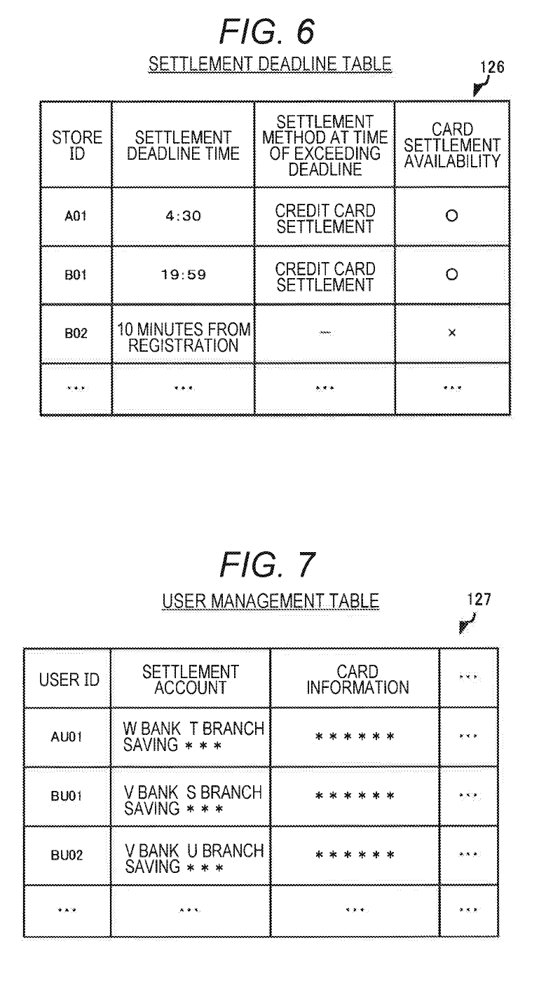

FIG. 6 shows an example of the settlement deadline table 126 according to this embodiment. The settlement deadline table 126 is a table where a deadline of settlement processing by the settlement processing system 100 is defined for each store.

A data structure thereof is an aggregation of records including data such as a settlement deadline time, a settlement method at the time of exceeding a deadline, and card settlement availability, with a store ID as a key.

Among them, the “settlement deadline time” becomes a time of a settlement deadline according to a closing time of sales data in each store. In addition, the “settlement method at the time of exceeding the deadline” is a settlement method in the case where the “settlement deadline time” has passed and becomes a desired settlement method of each store. In addition, the “card settlement availability” shows whether or not credit card settlement can be used in the store.

FIG. 7 shows an example of the user management table 127 according to this embodiment. The user management table 127 is a table in which information of users to be customers who use the store is accumulated.

A data structure thereof is an aggregation of records including data such as a settlement account of a user and card information, with a user ID to uniquely specify the user as a key. Of these, the “settlement account” is a bank account that becomes a remittance source in remittance processing from the user to a used store in the settlement opportunity in each store with respect to the user.

In addition, the “card information” is information of a credit card to be a substitution settlement mechanism, when a settlement opportunity is generated at a time past the “settlement deadline time”, with respect to the user.

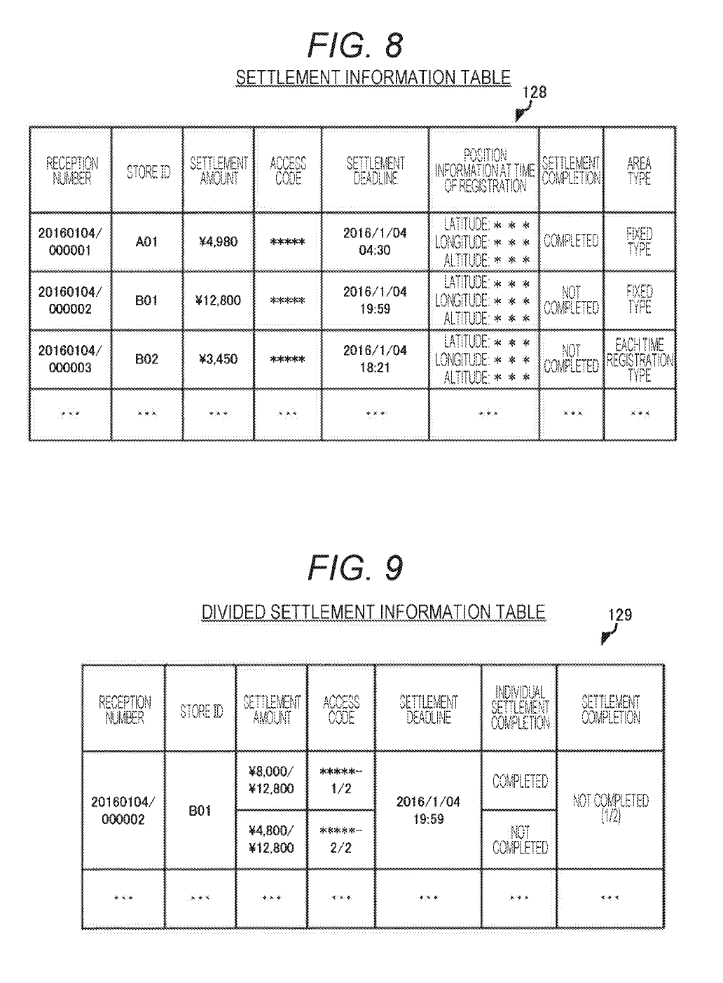

FIG. 8 shows an example of the settlement information table 128 according to this embodiment. The settlement information table 128 is a table in which settlement information corresponding to a settlement opportunity generated in each store is accumulated. A data structure thereof is an aggregation of records including data such as a store ID of a store, a settlement amount, an access code, a settlement deadline, position information at the time of registration, settlement completion, and an area type, with a number when the settlement information is received from the store terminal 200, that is, a reception number as a key. Among them, the settlement amount becomes an amount to be remitted to the store from a user of the store to the store at the time of the settlement opportunity.

FIG. 9 shows an example of the divided settlement information table 129 according to this embodiment. The divided settlement information table 129 is a table generated when intention notification of payment sharing (so-called bill-splitting) by a plurality of persons is received from the user terminal 300, with respect to the settlement information registered in the settlement information table 128.

A data structure thereof is an aggregation of records including data such as a store in which the settlement opportunity has been generated, a settlement amount, an access code, a settlement deadline, individual approval completion, and settlement completion, with a reception number of the settlement information to be a target of the intention notification of the payment sharing as a key.

Among them, the “settlement amount” shows a share of each user in a value of the “settlement amount” of the settlement information in the settlement information table 128. The example of FIG. 9 shows a situation in which, with respect to settlement information of a reception number “20160104/000002”, one user shares “¥8,000” in an original settlement amount “¥12,800” and the other user shares “¥4,800”. According to the sharing of the settlement amount, in the access code, a value “−1/2” is assigned to the first person and a value “−2/2” is assigned to the second person.

In addition, a value of the “individual settlement completion” becomes “completed” when each user has completed the settlement of the share and becomes “not completed” when the settlement is not completed. When all columns of the “individual settlement completion” with respect to one reception number have become “completed”, a value of a “settlement completion” column becomes “completed”. On the other hand, when one of the columns of the “individual settlement completion” with respect to one reception number becomes “not-completed”, the value of the “settlement completion” column becomes “not-completed”. In the example of FIG. 9, in the “settlement completion” column, a value such as “1/2” (that is, completion of only one of two individual settlements in all) showing a completion situation of the individual settlement is additionally registered.

### ———First Flow Example———

Hereinafter, an actual procedure of a settlement processing method according to this embodiment will be described on the basis of the drawings. Various operations corresponding to the settlement processing method to be described below are realized by a program that is read onto the memory 103 by the settlement processing system 100 and executed. In addition, the program includes codes for performing the various operations to be described below.

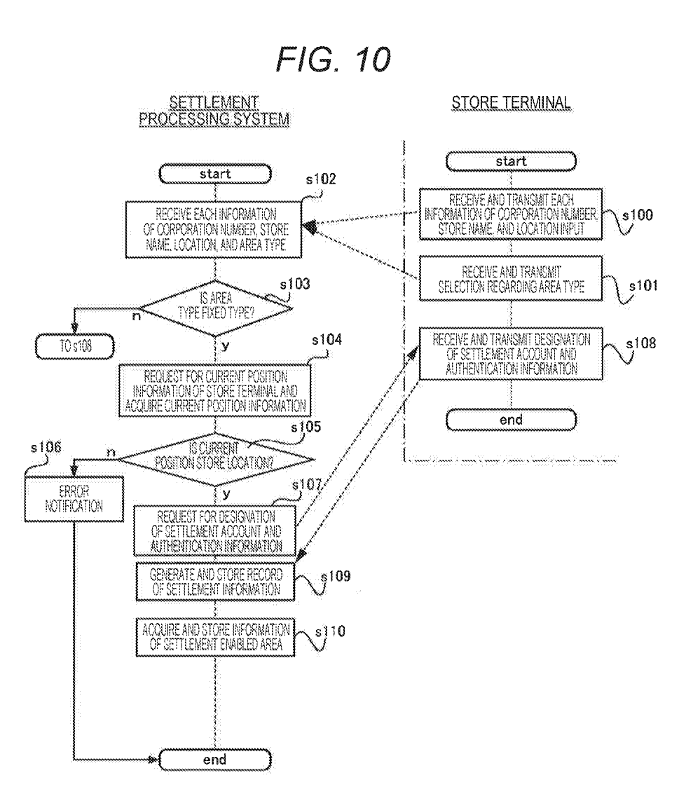

FIG. 10 is a diagram showing a first flow example of the settlement processing method according to this embodiment. Here, first, a flow of registering information regarding the store in the corporation management table 125 will be described. The store terminal 200 downloads and installs the application 2025 from an appropriate server system such as the settlement processing system 100, at the time of starting the flow.

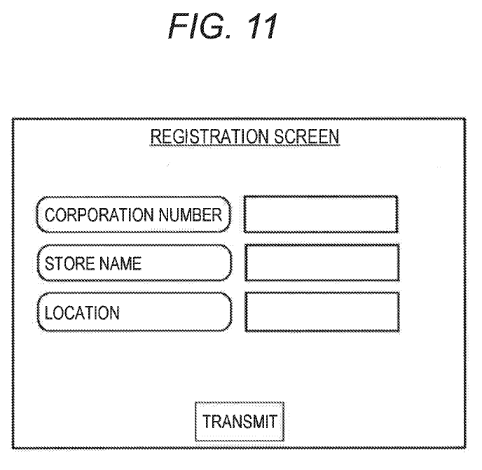

The store terminal 200 displays an interface (for example, refer to FIG. 11) of the application 2025 on the input/output device 205 and receives each information of a corporation number, a store name, and a location input from a store staff (s100). In s100, the store terminal 200 transmits each piece of obtained information to the settlement processing system 100. Here, the corporation number in the information received by the store terminal 200 is not essential. For example, in the case where an operator of the store does not have a juridical personality and is a sole proprietor, the store terminal 200 may receive a name of a representative and the like instead of the corporation number.

In addition, the store terminal 200 receives selection regarding the area type of the store by the input/output device 205 (s101). In s101, the store terminal 200 transmits information of the received area type to the settlement processing system 100.

On the other hand, the settlement processing system 100 receives each information of the corporation number, the store name, the location, and the area type for the store, from the store terminal 200 (s102).

Next, the settlement processing system 100 determines whether the area type of the store obtained in s102 is the “fixed type” or the “each time registered type” (s103). As a result of the determination, when the area type selected for the store is the “each time registration type” (s103: n), the settlement processing system 100 causes the processing to proceed to s108.

On the other hand, as the result of the determination, when the area type selected for the store is the “fixed type” (s103: y), the settlement processing system 100 requests the store terminal 200 to transmit current position information measured by the GPS unit 210 and acquires the current position information (s104).

Next, the settlement processing system 100 determines whether or not the current position information obtained from the store terminal 200 shows the location acquired for the store in s100 (s105).

As a result of the determination, when it is determined that the current position of the store terminal 200 is not at the location of the store (s105: n), the settlement processing system 100 returns a predetermined error notification showing that “the store location and the current position of the store terminal are not matched with each other” to the store terminal 200 (s106) and temporarily ends the processing.

On the other hand, as the result of the determination, when it is determined that the current position of the store terminal 200 is at the location of the store (s105: y), the settlement processing system 100 requests the store terminal 200 to designate information of a settlement account of the store and authentication information (for example, a password) necessary for using the application 2025 installed in the store terminal 200 (s107).

The store terminal 200 receives the request, causes the input/output device 205 to display the request, and receives the information of the settlement account and input of the authentication information of the account from the staff of the store (s108). In s108, the store terminal 200 transmits each received information of the settlement account and the authentication information to the settlement processing system 100.

In this case, the store terminal 200 may not transmit the authentication information to the settlement processing system 100, but may set the authentication information to the application 2025 to be held by the store terminal 200.

The settlement processing system 100 receives the settlement account and the authentication information transmitted from the store terminal 200, associates the settlement account and the authentication information with each information of the corporation number, the store name, the location, and the area type for the store, obtained in s102, generates a record, and stores the record in the corporation management table 125 (s109). In step s109, the settlement processing system 100 generates a store ID for the store by a predetermined algorithm and stores the store ID in the record.

Next, the settlement processing system 100 transmits a designation request for the settlement enabled area for the store to the store terminal 200, acquires a reply, that is, information of the “registration point” from the store terminal 200, and stores the information in a “registration point” column in the record of the store (s110).

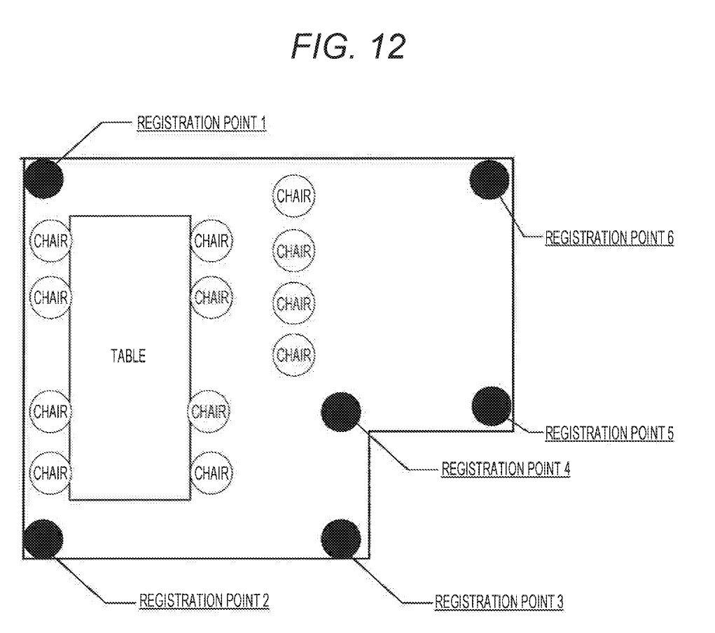

In this case, the store terminal 200 causes a predetermined map (refer to FIG. 12) including the location of the store in which matching with the current position of the store terminal 200 has been secured in the determination of s105 to be displayed. The staff of the store who browses the map moves on the map while carrying the store terminal 200 and inputs a point registration instruction at each vertex on the boundary line of the settlement enabled area. If a shape of the settlement enabled area considered by the staff is a rectangular shape, the point registration instruction is input at four vertexes. Of course, the shape of the settlement enabled area is not limited. Any shape may be used as long as it is a shape of a closed figure that can define one area.

On the other hand, the store terminal 200 receives each of the point registration instructions by the input/output device 205 and acquires the current position information from the GPS unit 210 and transmits it to the settlement processing system 100 each time when the instruction is received. In the above example, four pieces of current position information are transmitted.

On the other hand, the settlement processing system 100 receives the current position information according to each point registration instruction transmitted from the store terminal 200 as described above and stores it in the “registration point” column in the record of the store.

Although not described in detail, it is assumed that the application 3025 is downloaded from the settlement processing system 100 and is installed in the user terminal 300 of each user. In addition, it is assumed that the information of the settlement account of the user is input via the application 3025 and registered in the user management table 127 of the settlement processing system 100.

### ———Second Flow Example———

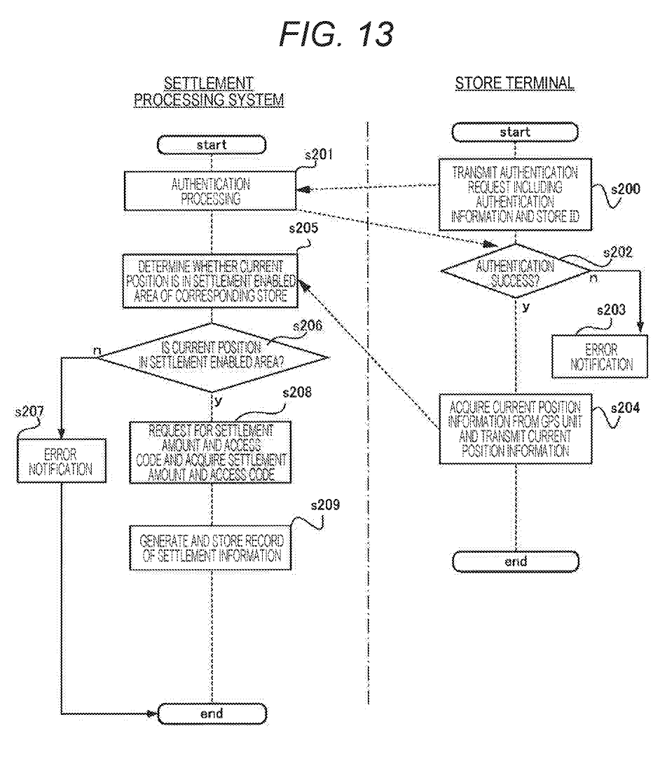

Next, registration processing of settlement information according to generation of the settlement opportunity in the store will be described. FIG. 13 is a diagram showing a second flow example of the settlement processing method according to this embodiment.

In this case, the staff of the store starts the application 2025 in the store terminal 200 and inputs authentication information such as a password. The store terminal 200 transmits an authentication request including the authentication information and a store ID of the store to the settlement processing system 100 (s200). Of course, when the application 2025 holds the authentication information, the application 2025 executes the authentication processing by collation between the authentication information. For this reason, transmission of the authentication request is unnecessary. Operations related to the authentication may be performed appropriately according to the situation.

As a result of the authentication request, when a result of an authentication failure is obtained through the authentication processing (s201) in the settlement processing system 100 (s202: n), the application 2025 of the store terminal 200 displays an authentication error message on the input/output device 205 (s203) and temporarily ends the processing.

On the other hand, as the result of the authentication request, when a result of authentication success is obtained from the settlement processing system 100 (s202: y), the store terminal 200 acquires the current position information from the GPS unit 210 and transmits it to the settlement processing system 100 (s204).

On the other hand, the settlement processing system 100 receives the current position information of the store terminal 200 and determines whether or not the current position information shows the inside of the settlement enabled area of the store (s205). At the time of this processing, the settlement processing system 100 extracts values of respective registration points held by the corporation management table 125 for the store and determines whether or not the GPS coordinate value to be the current position information is included in an area obtained by coupling the values. Of course, at the time of the determination, the “permission range” for the store is specified by the corporation management table 125 and even when the current position of the store terminal 200 is outside the area, it is determined whether or not the current position is included in the permission range.

As a result of the determination, when it is determined that the store terminal 200 is not located in the settlement enabled area (s206: n), the settlement processing system 100 transmits an error message showing that “the store terminal is located outside the settlement enabled area” to the store terminal 200 (s207) and ends the processing.

On the other hand, as the result of the determination, when it is determined that the store terminal 200 is located in the settlement enabled area (s206: y), the settlement processing system 100 transmits an input request for a settlement amount and an access code in the settlement opportunity to the store terminal 200 and acquires them (s208).

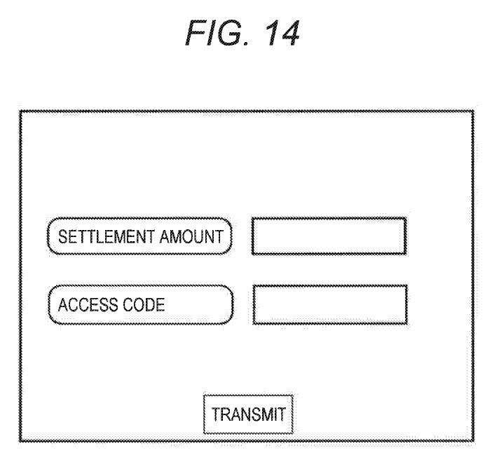

In this case, the application 2025 of the store terminal 200 causes the input/output device 205 to display an interface (refer to FIG. 14) for inputting the settlement amount and the access code. The staff of the store inputs the settlement amount and the access code in the settlement opportunity through the interface. The access code is a code uniquely associated with each settlement opportunity. Therefore, in addition to the case where the access code is considered and input by the staff of the store, the application 2025 may automatically generate the access code by a predetermined algorithm. Alternatively, the settlement processing system 100 may receive a request from the application 2025, generate the access code, and return the access code to the application 2025 of the store terminal 200.

In response to acquiring the settlement amount and the access code from the store terminal 200 in s208, the settlement processing system 100 generates a record including the settlement amount and the access code, gives a reception number to the record, stores the record in the settlement information table 128 (s209), and ends the flow. The staff of the store transmits the access code in the settlement opportunity to the user according to the registration completion. However, a transmission method does not matter. For example, various transmission methods such as the case where a piece of paper describing the access code is handed out to the user, the case where the access code is transmitted from the store terminal 200 to the user terminal 300 by appropriate short-range wireless communication such as infrared rays, and the case where the access code is transmitted simply orally can be adopted.

If the settlement information table 128 already shown in FIG. 8 is used as an example, a record of a reception number “20160104/000001” is generated by obtaining settlement information from the store terminal 200 of a store having a store ID “A01”, a settlement amount in the settlement opportunity is “¥4,980”, and an access code is “*****”.

A value of the “settlement deadline” in the record is obtained by specifying a settlement deadline time of the store “A01” in the settlement deadline table 126 and setting the time to a settlement deadline at a generation date of the record, by the settlement processing system 100.

In addition, the “position information at the time of registration” becomes the current position information (obtained in s204) of the store terminal 200 where the location within the settlement enabled area has been confirmed by the determination in step s206. Because the settlement processing is not performed at the execution time of the flow, a value of “not completed” is set to the “settlement completion” column.

In addition, the “area type” column has a value of the area type specified in the corporation management table 125 by the settlement processing system 100, on the basis of the store ID “A01”.

### ———Third Flow Example———

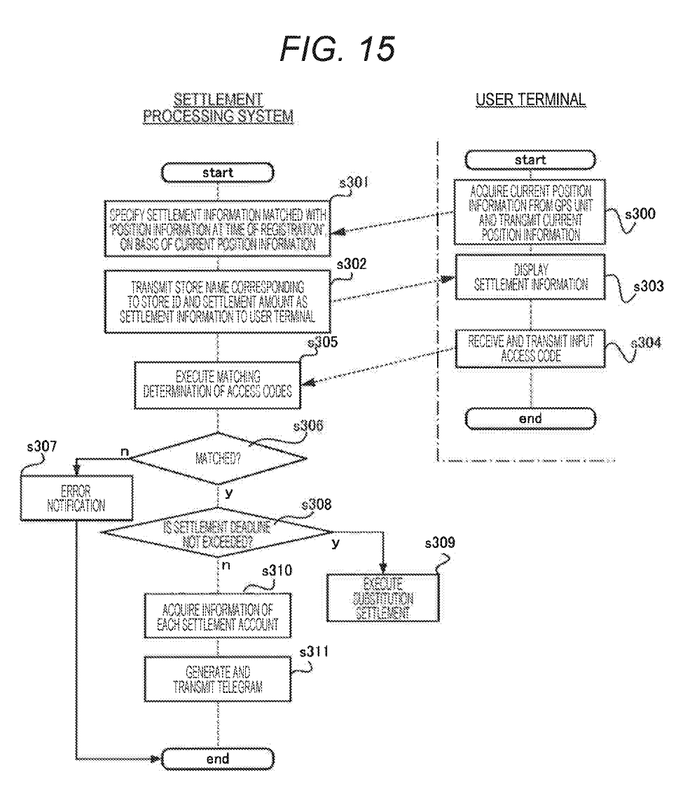

Next, a flow of settlement between a user who makes a payment in the settlement opportunity and a store receiving the payment, that is, remittance processing will be described. FIG. 15 is a diagram showing a third flow example of the settlement processing method according to this embodiment.

Here, it is assumed that the user starts the application 3025 in the user terminal 300. The started application 3025 acquires the current position information from the GPS unit 310 and transmits it to the settlement processing system 100 (s300).

The settlement processing system 100 receives the current position information transmitted from the application 3025, collates it with each record in the settlement information table 128, and specifies a record in which the “position information at the time of registration” is matched, that is, settlement information (s301).

Next, the settlement processing system 100 reads the store ID from the specified record, specifies the store name corresponding to the store ID in the corporation management table 125, and transmits the store name and the settlement amount shown by the settlement information as the settlement information to the user terminal 300 (s302).

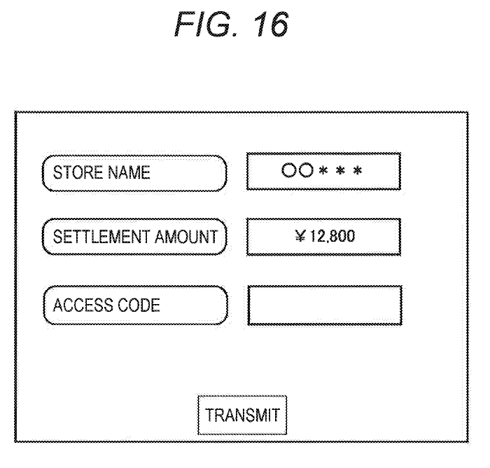

The user terminal 300 receives the settlement information including the information of the store name and the settlement amount and causes the input/output device 205 to display the information (s303). The user browses the settlement information (refer to FIG. 16) and confirms settlement content. In the case where a plurality of pieces of settlement information is displayed, the user appropriately selects a target to be processed. Then, the user inputs the access code previously notified by the staff of the store for the settlement information of a settlement target, to the application 3025.

The application 3025 of the user terminal 300 receives the input access code and transmits a collation request including the access code to the settlement processing system 100 (s304).

The settlement processing system 100 receives the access code from the user terminal 300 and determines whether or not the access code is matched with an access code in the corresponding record of the settlement information table 128 (s305).

As a result of the determination, when the access codes are not matched (s306: n), the settlement processing system 100 returns an error message showing that the “access codes are not matched” to the user terminal 300 (s307) and causes the flow to return to s305 or ends the processing.

On the other hand, as the result of the determination, when the access codes are matched (s306: y), the settlement processing system 100 refers to a value of the settlement deadline in the settlement information table 128 and determines whether or not the value does not exceed a current date and time (s308).

As a result of the determination, when the settlement deadline exceeds the current date and time (s308: n), the settlement processing system 100 returns a message showing that the settlement deadline has passed to the user terminal 300, specifies a settlement method at the time of exceeding the deadline of the store in the settlement deadline table 126, and executes settlement processing by the settlement method (s309).

For example, in the settlement deadline table 126 of FIG. 6, a settlement method at the time of exceeding the deadline in the store “A01” is “credit card settlement”. When the user ID of the user to be one subject in the settlement is “AU01”, card information can be acquired in the user management table 127. Therefore, the settlement processing system 100 notifies a credit card company of a settlement request of the settlement amount with the credit card shown by the card information.

On the other hand, as the result of the determination, when the settlement deadline does not exceed the current date and time (s308: y), the settlement processing system 100 acquires the information of the settlement account from the corporation management table 125 with the store ID included in the settlement information as a key. Similarly, the settlement processing system 100 acquires the information of the settlement account from the user management table 127 with the user ID of the user obtained from the application 3025 as a key (s310).

In addition, the settlement processing system 100 generates a telegram requesting for remitting the settlement amount from the settlement account of the user to the settlement account of the store, on the basis of the information of the settlement account obtained in s310 and the information of the settlement amount, and transmits it to the accounting system 400 (s311).

In such remittance processing, the account of the remittance source and the account of the remittance destination are preferably opened in the same financial institution, more preferably, the same branch office, because a remittance charge is very low. Therefore, an operation may be performed such that the store and the user who is the customer thereof open the settlement accounts in the same financial institution.

Here, in the above flow, for example, in step s305, the settlement processing system 100 may receive the access code and the intention notification of payment sharing by a plurality of persons in the settlement opportunity, from the user terminal 300.

The intention notification can be regarded as having the access code to which a predetermined consecutive value according to the number of people is given. Alternatively, it may be notification of the number of users who share payment.

For example, when the access code is “1234” and there are two users who share payment, the user terminal 300 that has received an instruction of the number of people gives values of “1/2” and “2/2” to the access code and generates access codes “1234-1/2” and “1234-2/2”. Of course, this processing may be performed by the user or may be executed by the settlement processing system 100 that has received the notification of the number of people from the user terminal 300.

In this case, the user terminal 300 or the settlement processing system 100 executes processing for dividing the settlement amount associated with the original access code “1234” by the number of users who share the payment or dividing the settlement amount by an amount designated by the user and specifies the settlement amount for each user.

By the above processing, settlement information corresponding to each user who shares the payment is stored in the divided settlement information table 129 by the user terminal 300 or the settlement processing system 100.

The settlement processing system 100 executes the same processing as the transmission of the settlement information to the user terminal 300 (s302), the determination of matching between the access code received from the user terminal 300 and the access code based on the divided settlement information table 128 (s305 and s306), the determination of the excess of the settlement deadline (s307 and s308), the settlement processing at the time of exceeding the settlement deadline (s309), the information acquisition of the settlement account (s310), and the transmission of the settlement request telegram to the accounting system 400 (s311), on the basis of the settlement information of each user corresponding to the new access code.

In addition, when the individual settlement processing for each user who shares payment has been completed through transmission of the settlement request telegram, the settlement processing system 100 determines that the settlement processing of the settlement information (in the above example, the access code “1234”) has been completed, sets the completion of the settlement processing to the “settlement completion” column of the divided settlement information table 129, notifies the user terminal 300 of the completion of the settlement processing, and ends the processing.

When it is determined that all of the individual settlement processing have been completed, an event in which all of the “individual settlement completion” columns for the reception numbers in the divided settlement information table 129 have become “completed” may be detected or an event in which a sum of remittance amounts by the remittance processing between the settlement accounts of each of the plurality of users and the store has been matched with the settlement amount of the access code “1234” (the value of the settlement information table 128) may be detected.

Among the above processing based on the flow of FIG. 15, the processing by the user terminal 300 may be performed by the store terminal 200 and the partner with which the settlement processing system 100 exchanges data may be the store terminal 200. Such a mode can be applied, for example, to the case where the user does not possess an appropriate terminal and the user temporarily borrows the store terminal 200 of the store and inputs an access code.

According to the settlement processing technology according to this embodiment, quick and low-cost cashless settlement is enabled. Specifically, even in the store where the credit card settlement (including the debit settlement) cannot be introduced in the past, cashless settlement can be easily introduced without worrying about the settlement fee and the introduction cost of a dedicated terminal (for example: POS).

By the description of the present specification, at least the following will be clarified. That is, in the settlement processing system according to this embodiment, the operation device may further execute processing for, when a registration request including each information of a current position, a desired registration address, and a settlement account of a predetermined store is received from a store terminal of the predetermined store and the information of the current position shows the desired registration address, storing the current position as the registration position information in the storage device in association with information of the settlement account, for the store.

According to this, information registration for the store is executed only when the current position where the store terminal is actually located and the address to be registered for the store are matched with each other. Accordingly, it is possible to exclude registrations of malicious third parties who declare fictitious stores or false addresses to attempt illegal settlement. As a result, quick and low-cost cashless settlement can be executed in an appropriate secure environment.

In addition, in the settlement processing system according to this embodiment, the operation device may further execute processing for, when the registration position information and the information of the settlement account are stored, receiving designation of a predetermined range including a position shown by the registration position information from the store terminal and storing information of the designated predetermined range as information of the predetermined area in the storage device.

According to this, it is possible to previously limit the area where the settlement operation is enabled even in the store and to exclude unclear settlement procedures in a place capable of avoiding public eyes. In addition, quick and low-cost cashless settlement can be executed under an appropriate secure environment.

In addition, in the settlement processing system according to this embodiment, when each of a plurality of payment requests obtained in a predetermined period includes the same predetermined code to which a predetermined value showing intention of payment sharing by a plurality of users is assigned, the operation device may execute a request for remittance processing between each of the plurality of users and a settlement account of the store based on each of the payment requests and when there is no problem in each reply result from the accounting system as a result of each request for each of the plurality of users, the operation device may output a message showing that settlement for settlement information associated with the predetermined code has been completed to a predetermined device.

According to this, it is possible to perform quick and low-cost cashless settlement while coping with a user who desires to make a payment by so-called bill-splitting.

In the settlement processing method according to this embodiment, the information processing system may further execute processing for, when a registration request including each information of a current position, a desired registration address, and a settlement account of a predetermined store is received from a store terminal of the predetermined store and the information of the current position shows the desired registration address, storing the current position as the registration position information in the storage device in association with information of the settlement account, for the store.

In addition, in the settlement processing method according to this embodiment, the information processing system may further execute processing for, when the registration position information and the information of the settlement account are stored, receiving designation of a predetermined range including a position shown by the registration position information from the store terminal and storing information of the designated predetermined range as information of the predetermined area in the storage device.

In addition, in the settlement processing method according to this embodiment, when each of a plurality of payment requests obtained in a predetermined period includes the same predetermined code to which a predetermined value showing intention of payment sharing by a plurality of users is assigned, the information processing system may execute a request for remittance processing between each of the plurality of users and a settlement account of the store based on each of the payment requests and when there is no problem in each reply result from the accounting system as a result of each request for each of the plurality of users, the information processing system may output a message showing that settlement for settlement information associated with the predetermined code has been completed to a predetermined device.

### REFERENCE SIGNS LIST

10 network
100 settle processing system
101 storage device
102 program
103 memory
104 operation device
105 communication device
125 corporation management table
126 settlement deadline table
127 user management table
128 settlement information table
129 divided settlement information table
200 store terminal
201 storage device
202 program
2025 application
203 memory
204 operation device
205 input/output device
206 communication device
210 GPS unit
300 user terminal
301 storage device
302 program
3025 application
303 memory
304 operation device
305 input/output device
306 communication device
310 GPS unit
400 accounting system

1. A settlement processing system, comprising:
a storage device which stores registration position information showing a location of each store, settlement account information of the store, and settlement account information of a user of each store; and
an operation device which executes
processing for, when current position information obtained from a store terminal of the store shows the inside of a predetermined area shown by the registration position information of the store, obtaining a predetermined code and settlement information corresponding to a settlement opportunity generated for the user of the store, from the store terminal and storing the predetermined code and the settlement information in the storage device, according to the settlement opportunity, and
processing for, when a payment request including the predetermined code is obtained from a predetermined user terminal, specifying a store located at a current position of the user terminal, on the basis of current position information obtained from the user terminal and the registration position information, and when a predetermined code held for the store and the predetermined code included in the payment request are matched with each other, requesting an accounting system to execute remittance processing between settlement accounts of the user and the store, on the basis of settlement information associated with the predetermined code and the settlement account information of the store and the user.

2. The settlement processing system according to claim 1, wherein
the operation device further executes processing for, when a registration request including each information of a current position, a desired registration address, and a settlement account of a predetermined store is received from a store terminal of the predetermined store and the information of the current position shows the desired registration address, storing the current position as the registration position information in the storage device in association with information of the settlement account, for the store.

3. The settlement processing system according to claim 2, wherein
the operation device further executes processing for, when the registration position information and the information of the settlement account are stored, receiving designation of a predetermined range including a position shown by the registration position information from the store terminal and storing information of the designated predetermined range as information of the predetermined area in the storage device.

4. The settlement processing system according to claim 1, wherein,
when each of a plurality of payment requests obtained in a predetermined period includes the same predetermined code to which a predetermined value showing intention of payment sharing by a plurality of users is assigned, the operation device executes a request for remittance processing between each of the plurality of users and a settlement account of the store based on each of the payment requests, and
when there is no problem in each reply result from the accounting system as a result of each request for each of the plurality of users, the operation device outputs a message showing that settlement for settlement information associated with the predetermined code has been completed to a predetermined device.

5. A settlement processing method, wherein
an information processing system, which includes a storage device storing registration position information showing a location of each store, settlement account information of the store, and settlement account information of a user of each store, executes
processing for, when current position information obtained from a store terminal of the store shows the inside of a predetermined area shown by the registration position information of the store, obtaining a predetermined code and settlement information corresponding to a settlement opportunity generated for the user of the store, from the store terminal and storing the predetermined code and the settlement information in the storage device, according to the settlement opportunity, and
processing for, when a payment request including the predetermined code is obtained from a predetermined user terminal, specifying a store located at a current position of the user terminal, on the basis of current position information obtained from the user terminal and the registration position information, and when a predetermined code held for the store and the predetermined code included in the payment request are matched with each other, requesting an accounting system to execute remittance processing between settlement accounts of the user and the store, on the basis of settlement information associated with the predetermined code and the settlement account information of the store and the user.

6. The settlement processing method according to claim 5, wherein
the information processing system further executes processing for, when a registration request including each information of a current position, a desired registration address, and a settlement account of a predetermined store is received from a store terminal of the predetermined store and the information of the current position shows the desired registration address, storing the current position as the registration position information in the storage device in association with information of the settlement account, for the store.

7. The settlement processing method according to claim 6, wherein
the information processing system further executes processing for, when the registration position information and the information of the settlement account are stored, receiving designation of a predetermined range including a position shown by the registration position information from the store terminal and storing information of the designated predetermined range as information of the predetermined area in the storage device.

8. The settlement processing method according to claim 5, wherein
when each of a plurality of payment requests obtained in a predetermined period includes the same predetermined code to which a predetermined value showing intention of payment sharing by a plurality of users is assigned, the information processing system executes a request for remittance processing between each of the plurality of users and a settlement account of the store based on each of the payment requests and when there is no problem in each reply result from the accounting system as a result of each request for each of the plurality of users, the information processing system outputs a message showing that settlement for settlement information associated with the predetermined code has been completed to a predetermined device.
